(19) United States
(12) Patent Application Publication
(10) Pub. No.: US 2010/0123303 A1
(43) Pub. Date: May 20, 2010

(54) GAS GENERATING SYSTEM WITH THERMAL BARRIER

(76) Inventor: John H. Boucher, Washington Township, MI (US)

Correspondence Address: L.C. Begin & Associates, PLLC, 510 Highland Avenue, PMB 403, Milford, MI, 48381, US

(21) Appl. No.: 12/621,420

(22) Filed: Nov. 18, 2009

Related U.S. Application Data
(60) Provisional application No. 61/199,567, filed on Nov. 18, 2008.

(51) Int. Cl. B60R 21/16

(52) U.S. Cl. 280/743.1; 280/728.1

(57) ABSTRACT

A housing unit for a gas generating system, the housing unit comprising a housing and a thermally insulative barrier covering at least a portion of an exterior of the housing. Gas generating system and a vehicle occupant protection system incorporating the housing unit are also described.

### CROSS-REFERENCE TO RELATED APPLICATIONS

This application claims the benefit of U.S. Provisional Application Ser. No. 61/199,567 filed on Nov. 18, 2008.

### BACKGROUND OF THE INVENTION

The present invention relates to gas generating systems and, more particularly, to gas generating systems employing a selectively applicable thermally insulative barrier for attenuating the effects of elevated temperatures on gas generating system components.

### SUMMARY OF THE INVENTION

In one aspect of the embodiments of the present invention, a housing unit for a gas generating system is provided. The housing unit includes a housing and a thermally insulative barrier covering at least a portion of an exterior of the housing.

In another aspect of the embodiments of the present invention, a housing unit for a gas generating system is provided. The housing unit includes a housing and a thermally insulating barrier covering a portion of the housing so as to provide heating of an uncovered portion of the housing adjacent the covered portion at a greater rate than heating of the covered portion when heat from a heat source external to the housing impinges on the covered portion.

In another aspect of the embodiments of the present invention, a housing unit for a gas generating system is provided. The housing unit includes a longitudinal housing having an interior divided into first and second chambers, and a thermally insulating barrier covering a portion of the housing exterior of the first chamber.

### BRIEF DESCRIPTION OF THE DRAWINGS

In the drawings illustrating embodiments of the present invention:

FIG. 1 is a cross-sectional side view showing the outer housing, an insulating thermal barrier applied to the outer housing, and the internal structure of a gas generating system in accordance with an embodiment of the present invention.

FIG. 2 is a side exterior view of the embodiment shown in FIG. 1.

FIG. 3 is a cross-sectional end view of the gas generating system embodiment shown in FIG. 2.

FIG. 4 is a cross-sectional end view of a gas generating system in accordance with an alternative embodiment, showing the gas generating system housing spaced apart from the insulative thermal barrier.

FIG. 5 is a cross-sectional side view showing the outer housing, an insulating thermal barrier applied to the outer housing, and the internal structure of a gas generating system in accordance with another embodiment of the present invention.

FIG. 6 is a side exterior view of the embodiment shown in FIG. 5.

FIG. 7 is a schematic representation of an exemplary vehicle occupant protection system incorporating a gas generating system including a thermal barrier or insulating structure in accordance with one embodiment of the present invention.

### DETAILED DESCRIPTION

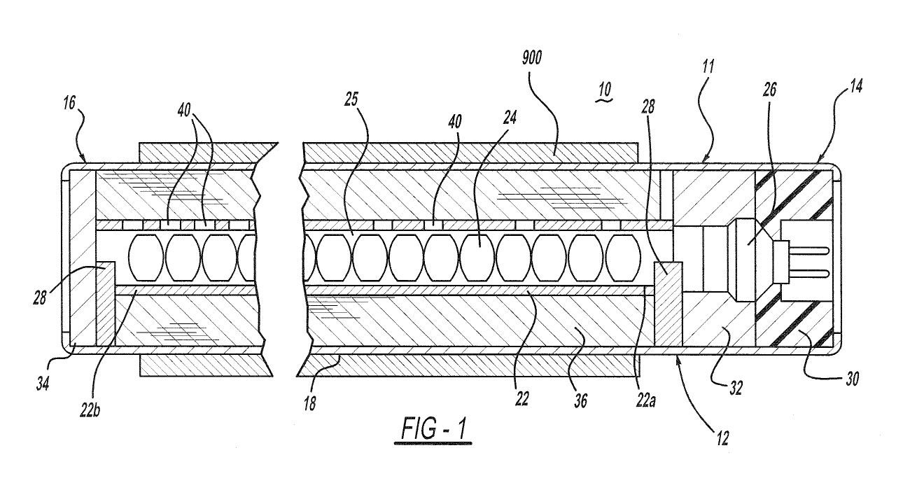

FIG. 1 shows a cross-sectional view of an outer housing and interior components, collectively designated 11, of a gas generating system 10 incorporating an insulative thermal shield or barrier in accordance with one embodiment of the present invention. The gas generating system may constructed of components made from a durable metal such as carbon steel or iron, but may also include components made from tough and impact-resistant polymers, for example. One of ordinary skill in the art will appreciate various methods of construction for the various components of the gas generating system. U.S. Pat. Nos. 5,035,757, 6,062,143, 6,347,566, U.S. patent application Ser. No. 2001/0045735, WO 01/08936, and WO 01/08937 exemplify typical designs for the various gas generating system components, and are incorporated herein by reference in their entirety, but not by way of limitation.

In the embodiment shown in FIG. 1, the gas generating system includes a tubular housing 12 having a pair of opposed ends 14, 16 and a housing wall 18. Housing 12 may be cast, stamped, extruded, or otherwise metal-formed. A plurality of gas exit apertures 20 are formed along housing wall 18 to permit fluid communication between an interior of the housing and an airbag (not shown).

A longitudinal gas generant enclosure 22 is inwardly radially spaced from housing 12 and is coaxially oriented along a longitudinal axis of the housing. Enclosure 22 has an elongate, substantially cylindrical body defining a first end 22a, a second end 22b, and an interior cavity for containing a gas generant composition 24 therein. Enclosure first end 22a is positioned to enable fluid communication between an igniter 26 and the enclosure interior cavity. Enclosure 22 is configured to facilitate propagation of a combustion reaction of gas generant 24 along the enclosure, in a manner described in greater detail below.

A plurality of gas generant tablets 24 are stacked side by side along the length of enclosure 22. In the embodiment shown in FIG. 1, each tablet 24 has substantially the same dimensions. Other, alternative arrangements of gas generant material are also possible. Examples of gas generant compositions suitable for use in the present invention are disclosed in U.S. Pat. Nos. 5,035,757, 6,210,505, and 5,872,329, incorporated herein by reference. However, the range of suitable gas generants is not limited to those described in the cited patents.

A quantity of a known auto-ignition composition 28 is positioned at either end of the stack of gas generant material 24. Enclosure 22 may be environmentally sealed at both ends with an aluminum tape (not shown) or any other effective seal, if desired. If desired, a quantity of a known booster compound (not shown) may be positioned in the housing so as to enable fluid communication between the booster compound and gas generant tablets 24 upon activation of the gas generating system. The booster compound facilitates ignition of the gas generant in a known manner.

An igniter 26 is mounted in the gas generating system such that the igniter is in communication with an interior of gas generant enclosure 22, for activating the gas generating system upon occurrence of a crash event. In the embodiment shown, igniter 26 is positioned within an annular bore of an igniter closure 30. Igniter 26 may be formed as known in the art. One exemplary igniter construction is described in U.S. Pat. No. 6,009,809, herein incorporated by reference.

Igniter closure 30 is crimped or otherwise fixed to a first end 14 of housing 12. A first endcap 32 is coaxially juxtaposed adjacent igniter closure 30 to form, in conjunction with igniter closure 30, an inner housing for igniter 26. First endcap 32 also provides a closure for gas generant enclosure 22. A second endcap 34 is crimped or otherwise fixed to a second end 16 of housing 12. Endcaps 32 and 34 and igniter closure 30 may be cast, stamped, extruded, or otherwise metal-formed. Alternatively, endcaps 32 and 34 may be molded from a suitable polymer.

A filter 36 may be incorporated into the gas generating system design for filtering particulates from gases generated by combustion of gas generant 24. In general, filter 36 is positioned between gas generant 24 and apertures 20 formed along gas generating system housing wall 18. In the embodiment shown in FIG. 1, filter 36 is positioned exterior of gas generant enclosure 22 intermediate enclosure 22 and housing wall 18, and substantially occupies the annular space between gas generant enclosure 22 and housing wall 18. In an alternative embodiment (not shown), filter 36 is positioned in the interior cavity of enclosure 22 between gas generant 14 and enclosure gas exit apertures 40 formed along enclosure 22. The filter may be formed from one of a variety of materials (for example, a carbon fiber mesh or sheet) known in the art for filtering gas generant combustion products.

In accordance with the present invention, a plurality of gas exit apertures 40 is formed along enclosure 22. If desired, apertures 40 may be spaced apart to tailor the rate of propagation of a combustion reaction of the gas generant 24 along the enclosure, as required by design criteria and as described in U.S. Pat. No. 7,080,854, incorporated herein by reference. Enclosure 22 may be roll formed from sheet metal and then perforated to produce apertures 40. Enclosure apertures 40 may be environmentally sealed with an aluminum tape 42 or any other effective seal.

Referring again to FIGS. 1-3, in the embodiments of the present invention described herein, a gas generating system 10 includes housing and components 11 and an external insulating structure or thermal barrier 900 applied to at least a portion of the outer surface of housing 12, to cover the portion of the housing. The thermally insulative barrier is a barrier containing one or more thermally insulating materials and which, by the performance of its thermal insulative function, permits transfer of heat and/or directs heat to a portion of the gas generating system in thermal communication with an auto-ignition material used for initiating combustion of a gas generant material located in the gas generating system, such that the auto-ignition material is ignited before the gas generating system housing becomes undesirably degraded or damaged.

Barrier 900 is designed to attenuate or mitigate the effects of elevated external housing temperatures (due, for example, to exposure to flame) on the covered portion(s) of the housing and/or any heat-sensitive internal gas generating system components residing on or within the covered portion of the housing. Barrier 900 may be selectively applicable so as to permit a high degree of control over the portion or portions of the housing covered by the barrier. This permits application of the barrier structure to selected portions of the housing while also permitting other portions of the housing in thermal contact with the auto-ignition material to remain exposed. Thus, sensitive portions of the housing and/or housing interior can be protected while still ensuring timely heat transfer to the auto-ignition compound, thereby permitting the auto-ignition compound to activate when desired.

Thermal insulating barrier 900 may be formed exclusively from one or more thermal insulating materials that impede heat transfer therethrough. Alternatively, thermal insulating barrier 900 may include both one or more thermal insulating materials and also materials containing one or more heat-reflective substance(s) that reflect heat away from the housing outer surface. Barrier 900 may also (or alternatively) include one or more flame retardant materials incorporated therein. For example, in one embodiment, harrier 900 includes a sheet or film of heat reflective material or flame retardant material which may possess minimal thermal insulative properties itself, but which can be applied over, under, or to the insulating material. One example of a suitable fire retardant material is Noxudol 999, available from Noxudol of North Hollywood, Calif. In a particular embodiment, the sheet or film is a pressure-sensitive, adhesive backed sheet or film comprising a polyimide material. One example of a heat reflective material suitable for the applications described herein is a sheet or film available under the designation “LG-1217”, available from LGI of Portland, Oreg.

Any of a variety of materials may be used for the insulating structure, including an suitable thermally-insulative polymers, films, coatings, structural ceramics, and/or other materials, which may be selected based on such factors as thermal insulation properties, flame-resistance or flame retardation, impact resistance, tear resistance and/or other factors, according to the requirements of a particular application. Also, layers of different materials having different thermal insulation properties may be overlaid or otherwise combined to achieve performance and manufacturing characteristics required for a particular application.

Materials are available for thermally insulating the housing in environments having a wide-range of external temperatures, depending on the requirements of a particular application. Insulation materials suitable for the purposes described herein include glass fiber matt or cloth, available from BGF Industries, Inc. of Greensboro, N.C. Other suitable insulation materials include carbon fiber cloth available from Jamestown Distributors of Bristol, R.I., and carbon fiber tubing, available from Highborn International Company. Other suitable insulation materials include glass-filled polymers, for example, glass-bead-filled polypropylene. Other suitable insulation materials include Kevlar® cloth and cloth composites available from BGF Industries, Inc. of Greensboro, N.C. Any other substance or combination of substances possessing thermal insulation properties suitable for the desired application may be used.

The insulation material may be in the form of layers which may be folded over or wrapped around the housing or a portion thereof. One example of a such a wrappable insulation material is Superwool® available from Thermal Ceramics Inc. of Augusta, Ga. In another embodiment, a thermal insulating material is sprayed onto the housing or a portion thereof. An example of a suitable material is Mega-Temp™ Insulation, available from Mega-Temp™ of Las Vegas, Nev.

In one embodiment, the insulating material is a moldable or formable material applicable directly to the housing using a caulking gun or pump. The material is then cured or dried to form an insulating layer which adheres to the housing material. Alternatively, the housing can be insert-molded into shroud or sleeve of suitable insulating material. Alternatively, the insulating material may be injected into a mold or otherwise formed into a jacket or receptacle into which the housing or a portion thereof is inserted. One example of a suitable material is ZIRCAR Alumina Insulation Type SALI Moldable available from ZIRCAR Ceramics, Inc. of Florida, N.Y. Other examples of suitable materials are castable ceramic compounds such as those available from Cotronics Corp. of Brooklyn, N.Y. Alternatively, a flexible insulative sleeving may be formed from a ceramic or other suitable material for receiving therein the housing or a portion thereof. Such sleeving is available from Cotronics Corp. of Brooklyn, N.Y. The material or materials forming the barrier may be amenable to printing of information thereon.

In another embodiment, an adhesive is applied to the housing exterior prior to application of the barrier structure. The adhesive secures one or more components of the insulating structure to the gas generating system housing. In a particular embodiment, the adhesive securing the barrier structure to the housing has thermal insulative thermal properties such that it augments the thermal insulative properties of the thermal barrier. Suitable high-temperature adhesives are available from various vendors, for example, Cotronics Corp. of Brooklyn, N.Y.

In another embodiment, a thermally insulative adhesive is applied to one or more layers or components of the insulating barrier, to secure these layers or components together. The adhesive may be applied and the barrier components bonded together such that the components are spaced apart and connected to each other only across the adhesive.

In one embodiment, a space or passage is provided between the insulating structure and the gas generating system housing. This provides an additional degree of thermal insulation between the exterior of the insulating structure and the gas generating system housing. In one particular embodiment, thermally insulating cells or voids are formed into the insulating material itself. One example of such a material is a closed-cell, cross linked polyolefin foam such as Thermobreak, available from Sekisui Pilon of Sydney, Australia.

The insulating structure may comprise a single layer of material or multiple layers of material. For example, in one particular embodiment, the gas generating system outer housing (or a suitable portion thereof) is covered with an inner layer having favorable insulative properties, while an outer layer having enhanced flame resistance and/or heat reflectivity encloses or covers the inner layer. In this manner, the performance of the insulative structure may be optimized to meet design requirements, with regard to such factors as material costs and material properties.

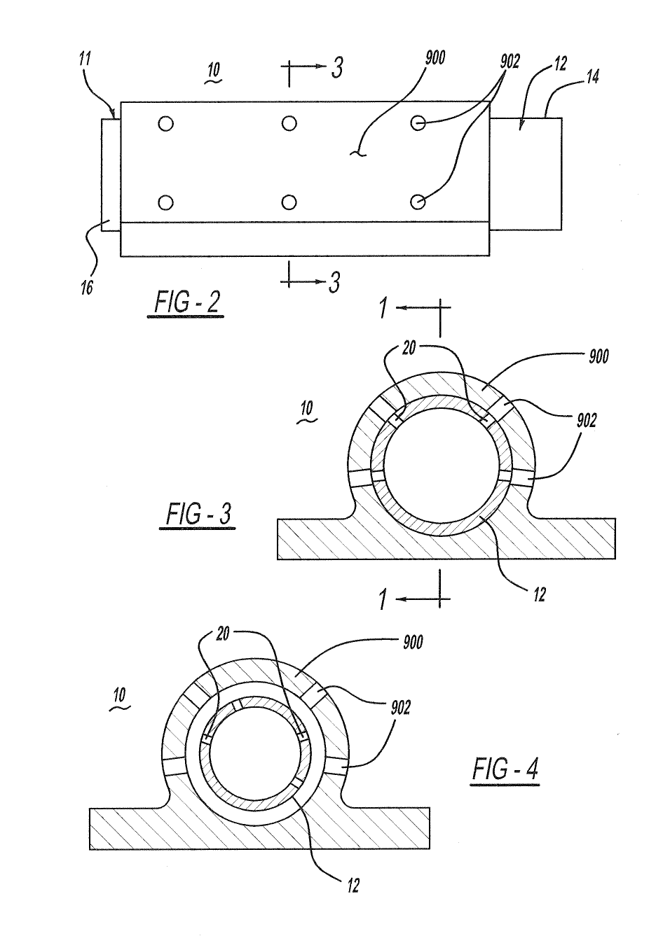

In a particular embodiment, the insulating structure covers most of the housing outer surface, as shown in FIGS. 2 and 3. In this embodiment, a portion of the housing proximate or in thermal communication with the auto-ignition material inside the housing may be left uncovered by the insulating structure, to expose this portion of the housing to externally-applied heat as previously described.

After application of insulating barrier 900 to housing 12, any of housing gas exit apertures 20 residing along a portion of the housing covered by the barrier must be either open or openable to expel generated gases. Any of a variety of methods may be employed for ensuring that apertures 20 will be capable of receiving generated gases therethrough. For example, through holes in a pattern conforming to the pattern of gas exit apertures along housing 12 may be pre-formed or molded into the barrier prior to application of the barrier to the housing. Alternatively, through holes in the barrier structure coincident with the gas exit aperture locations may be made after formation of the barrier structure. In another alternative embodiment, dowel pins may be inserted into apertures 20 prior to application of the barrier structure to the housing. This may facilitate application of the barrier structure by a molding, spraying or other process, if so desired. The pins may then be extracted from the holes after the barrier structure has been applied.

In the embodiment shown in FIGS. 2 and 3, insulating structure 900 is applied directly to (or is in substantially direct contact with) the gas generating system outer housing, and gas-exit openings 902 formed in the insulating structure are substantially aligned with gas-exit openings formed in gas generating system housing 12 to facilitate flow of gases from the housing.

In another embodiment (not shown), a space or passage is provided between the insulating structure and the gas generating system housing, and openings in insulating structure 900 are out of alignment with openings in the system housing. This forces gases exiting the system housing to flow along a passage prior to exiting openings 902, thereby facilitating cooling of the gases. In a particular embodiment (shown in FIG. 4), the gas-exit openings in the housing are spaced apart and non-aligned with the openings formed in the insulating structure, so that the generated gases are forced to flow along a tortuous path prior to exiting the insulating barrier. This enhances cooling of the gases prior to expulsion from the insulating barrier.

During operation, as explained previously, the barrier 900 attenuates or mitigate the effects of elevated external housing temperatures (due, for example, to exposure to flame) on the covered portion(s) of the housing and/or any heat-sensitive internal gas generating system components residing on or within the covered portion of the housing, while still ensuring timely heat transfer to the auto-ignition compound, thereby permitting the auto-ignition compound to activated when desired. This prevents thermally-induced damage to the housing and/or any heat-sensitive internal components.

The auto-ignition composition 28 previously described may be positioned in thermal contact with housing 12 such that heat transfer between the housing and the auto-ignition composition is facilitated when a portion of the housing not covered by thermal shield 900 is exposed to elevated exterior temperatures. For example, the auto-ignition composition may be placed in direct contact with the housing, or the housing and the auto-ignition composition may be thermally coupled by a heat-conductive material joined to both the auto-ignition composition and the housing. Numerous other alternatives modes of thermal connection between the housing and the auto-ignition composition are also contemplated.

In one particular embodiment, barrier 900 covers substantially the entire exterior of the housing. In another particular embodiment, barrier 900 covers only a portion (or multiple portions) of the housing. In both of these embodiments, however, a thermal path is provided from an exterior of the housing to portion(s) of the housing in thermal contact with the auto-ignition compound are left uncovered so that heat sufficient to ignite the auto-ignition material may be transferred to the material in a timely manner.

In a first embodiment (shown in FIGS. 1-3), thermal barrier 900 covers a substantial portion of the exterior of the housing. As seen in FIGS. 1 and 2, one or more end portions of the housing are in thermal communication with auto-ignition material 28 and are therefore left uncovered by the insulative barrier 900 so that externally generated heat sufficient to ignite an auto-ignition material residing within the housing proximate the exposed end portion(s) may be transferred to the auto-ignition material in a timely manner. In addition, in particular embodiments, it is believed that a quantity of heat impinging on covered portions of the housing may be deflected along the thermal barrier toward an exposed portion of the housing exterior which is in thermal communication with the auto-ignition material.

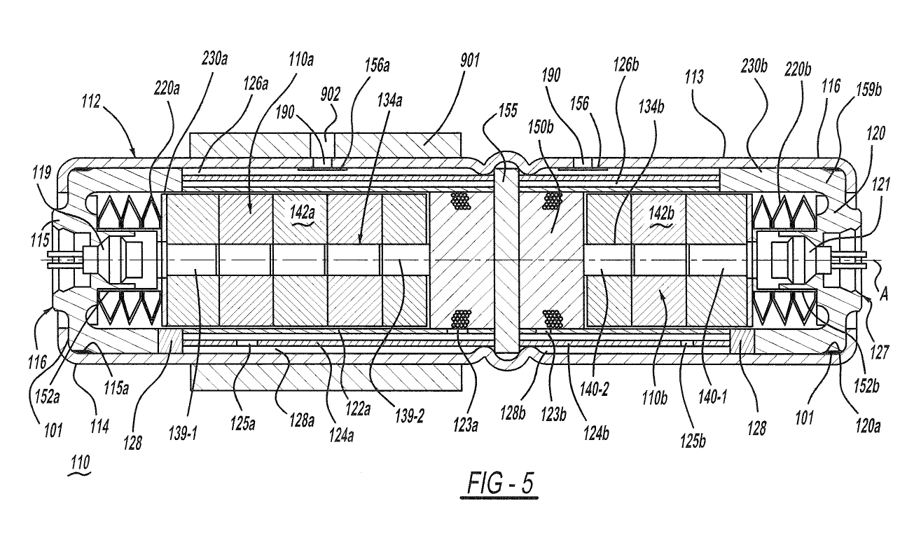

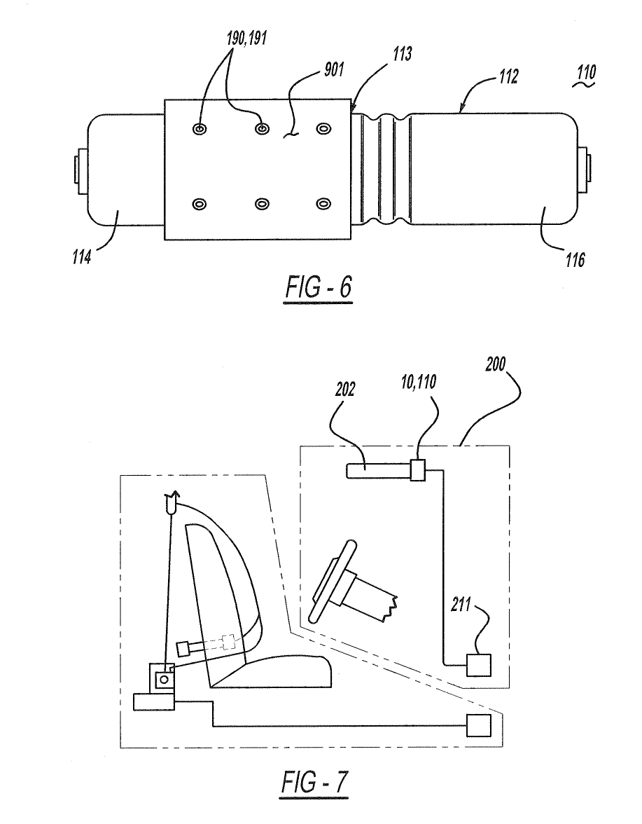

In another particular embodiment (shown in FIGS. 5 and 6), a thermal barrier 901 in accordance with the present invention is applied to a dual-chamber gas generating system 110. In combination, housing 112 and thermal barrier 901 form a thermally-shielded housing unit 113.

Referring to FIGS. 5 and 6, gas generating system 110 includes an elongate, substantially cylindrical housing 112, such as is well known in the art. Housing 112 has a first end 114 and a second end 116. A plurality of gas discharge apertures 190 are spaced along housing 112 to enable fluid communication between an interior of the housing and an exterior of the housing, the exterior of the housing being configured so as to enable fluid communication with an airbag (not shown) or other inflatable element of a vehicle occupant restraint system after activation of the gas generating system. Housing 112 also has a longitudinal central axis A, a wall 113 extending between ends 114 and 116, and openings formed at both ends of housing 112. The housing may be roll-formed, extruded, cast, or otherwise metal formed and may be made from aluminum, low carbon steel, or any other metal/alloy that is not gas permeable and that does not fragment during the burning of the gas generant enclosed therein.

A bulkhead 155 divides the interior volume of housing 112 into two portions, a first combustion chamber 110a and a second combustion chamber 110b arranged in a side-by-side configuration. Bulkhead 155 prevents fluid communication between first chamber 110a and second chamber 110b. Bulkhead 155 may be formed from the same material as housing 112, or from another suitable material. Bulkhead 155 may be positioned within housing 112 and secured therein, for example, by crimps formed along housing 112 on either side of the bulkhead. The positioning of bulkhead 155 along the interior of housing 112 may be adjusted such that chambers 110a and 110b are of different sizes, enabling a different quantity of gas generant composition to be positioned in each chamber, as shown in FIG. 5.

Bulkhead 155, along with filters 150a, 150b (described in greater detail below) also prevents sympathetic ignition within the gas generating system. Sympathetic ignition is defined herein as the ignition of a gas generant in one of combustion chambers 110a, 110b resulting from heat generated by the burning of gas generant in the other one of combustion chambers 110a, 110b. Sympathetic ignition would occur, for example, when a gas generant 142a is deliberately ignited in combustion chamber 110a by a first igniter 119, and where the heat and energy associated with the burning of gas generant 142a ignites gas generant 142b in second combustion chamber 110b. Bulkhead 155 and filters 150a, 150b absorb the heat from the burning of gas generants 142a and 142b to prevent sympathetic ignition.

Each of chambers 110a and 110b has the same basic arrangement of gas generating system components; thus, in general, the following discussion of the components in one of the chambers also applies to the components in the other chamber. Gas discharge apertures 190 may be covered with a foil 156 such as aluminum or stainless steel foil to prevent the incursion of water vapor into gas generating system housing 112. The foil 156, sometimes referred to as “burst foil” is typically of a thickness of from 0.01 to about 0.20 mm. The foil 156 is typically adhered to the interior surface of the housing 112 through the use of an adhesive.

A pair of substantially concentric baffle tubes 122a, 124a is positioned and secured within combustion chamber 110a, substantially centered about housing longitudinal axis A. Similarly, a pair of substantially concentric baffle tubes 122b, 124b is positioned and secured within combustion chamber 110b, also substantially centered about housing longitudinal axis A.

Baffle tubes 122a, 124a, 122b, 124b form, in conjunction with housing 112, a series of annular passages 126a, 128a, 126b, and 128b through which combustion gases propagate to discharge apertures 190 from interior portions of inner baffle tubes 122a, 122b. As is known in the art, baffle passages 126a, 128a, 126b, 128b are designed to cool the combustion products and to reduce or eliminate flaming of the combustion products prior to the products exiting the gas generating system through apertures 190. In alternative embodiments (not shown), more than two baffle tubes may be employed in one or more of combustion chambers 110a, 110b to further enhance cooling of the generated gases.

A plurality of gas discharge apertures 123a is spaced circumferentially around an end portion of inner baffle tube 122a to enable fluid communication between an interior of baffle tube 122a and an exterior of the baffle tube. Similarly, a plurality of gas discharge apertures 125a is spaced circumferentially around an end portion of outer baffle tube 124a to enable fluid communication between an interior of baffle tube 124a and an exterior of the baffle tube.

In addition, a plurality of gas discharge apertures 123b is spaced circumferentially around an end portion of inner baffle tube 122b to enable fluid communication between an interior of baffle tube 122b and an exterior of the baffle tube. Similarly, a plurality of gas discharge apertures 125b is spaced circumferentially around an end portion of outer baffle tube 124b to enable fluid communication between an interior of baffle tube 124b and an exterior of the baffle tube.

Endcaps 115, 120 are secured at respective first and second ends 114 116 of housing 112 to seal the openings provided in the housing ends. End caps 115, 120 may be stamped, cast, or otherwise metal formed and may be made from carbon steel or stainless steel, for example. End caps 115, 120 may be crimped, welded or clamped to housing 112 in a manner sufficient to ensure a gas tight seal between endcaps 115, 120 and housing 112, and in a manner sufficient to resist elevated internal housing pressures experienced during burning of the gas generant. In the embodiment shown in FIGS. 5-6, end portions of housing 112 are crimped over shoulders formed in end caps 115, 120.

A cavity may be formed in endcap 115 to accommodate an igniter 119 secured therein, thereby forming an igniter end cap assembly 116 as described below. Similarly, a cavity may be formed in endcap 120 to accommodate an igniter 121 secured therein, thereby foaming an igniter end cap assembly 127 as described below. Endcap 115 has an annular step portion 115a formed along an outer surface thereof for receiving a silicon sealing compound 101 therealong, as described in greater detail below. Similarly, endcap 120 has an annular step 120a portion formed along an outer surface thereof for receiving a silicon sealing compound 101 therealong. Step portions 115a and 120a are configured so as to provide a cavity between each of endcaps 115, 120 and housing 112 for receiving the silicon sealing compound 101 therein when the endcaps are crimped in position within housing 112.

Hermetic seals are formed between endcaps 115, 120 and housing 112 by using a two-part quick-cure silicon compound 101. Silicone compound 101 forms a seal at each end of gas generating system 110 when end portions of housing 112 are crimped to secure endcaps 115, 120 in position. The silicone compound may include an additive causing it to fluoresce when exposed to an ultraviolet light. This enables a relatively low-cost vision system to be used during gas generating system assembly to inspect for the presence of the silicone prior to crimping of the housing to secure the endcaps. Silicone sealants as contemplated for use in the present invention are commercially available from, for example, Electro Insulation Corporation of Arlington Heights, Ill.

Referring again to FIGS. 5 and 6, gas generating system 110 also includes first and second igniters 119, 121 for igniting the gas generant in respective ones of chambers 110a and 110b. Igniter 119 is secured to housing 112 such that the igniter is in communication with an interior of combustion chamber 110a and also with an exterior of the housing. Igniter 121 also is secured to housing 112 such that the igniter is in communication with an interior of combustion chamber 110b and also with an exterior of the housing. In the embodiment shown, igniter 119 is incorporated into an igniter end cap assembly 116 that includes igniter 119 and end cap 115. Similarly, igniter 121 is incorporated into an igniter end cap assembly 127 that includes igniter 121 and end cap 120. Igniter end cap assemblies 116 and 127 are positioned along central axis A to seal openings provided in the end portions of housing 112. Igniters 119 and 121 may be formed as known in the art. One exemplary igniter construction is described in U.S. Pat. No. 6,009,809, herein incorporated by reference. Igniters 119 and 121 may be twisted or screwed into respective endcaps 115 and 120. Other contemplated means of attaching the igniters to their respective endcaps include crimping, welding, and the like.

Referring again to FIGS. 5 and 6, an elongated propagation tube 134a is provided for channeling combustion products formed by ignition of igniter 119 down the length of combustion chamber 110a, thereby producing longitudinal propagation of gas generant combustion toward bulkhead 155. Similarly, an elongated propagation tube 134b is provided for channeling combustion products formed by ignition of igniter 121 down the length of combustion chamber 110b, thereby producing longitudinal propagation of gas generant combustion toward bulkhead 155. Propagation tube 134a has an elongate, substantially cylindrical body defining a first end 139-1, a second end 139-2, and an interior cavity. Propagation tube 134a also includes a plurality of apertures (not shown) spaced along a length thereof to enable fluid communication between igniter combustion products flowing along tube 134a and a quantity of gas generant composition 142a positioned in combustion chamber 110a alongside tube 134a.

Propagation tube 134b also has an elongate, substantially cylindrical body defining a first end 140-1, a second end 140-2, and an interior cavity. Propagation tube 134b also includes a plurality of apertures (not shown) spaced along a length thereof to enable fluid communication between igniter combustion products flowing along tube 134b and a quantity of gas generant composition 142b positioned in combustion chamber 110b alongside tube 134b.

Propagation tubes 134a, 134b may be extruded or roll formed from sheet metal and then perforated, In the embodiment shown in FIGS. 5 and 6, propagation tubes 134a and 134b are positioned within housing 112 to extend along central axis A of the housing. First end 139-1 of tube 134a is positioned to enable fluid communication between igniter 119 and the interior cavity of tube 134a. First end 140-1 of tube 134b is positioned to enable fluid communication between igniter 121 and the interior cavity of tube 134b. The elongate shapes of tubes 134a and 134b provide for combustion of gas generants 142a and 142b that propagates substantially from respective tube first ends 139-1, 140-1 toward respective tube second ends 139-2. 140-2. In an alternative embodiment (not shown), tubes 134a and 134b are omitted from the gas generating system.

Referring again to FIGS. 5 and 6, a cup 152a coupled to propagation tube 134a may enclose igniter 119 to define a fluid-tight interior portion of the cup in communication with the interior cavity of tube 134a and igniter 119. In addition, a cup 152b coupled to propagation tube 134b may enclose igniter 121 to define a fluid-tight interior portion of the cup in communication with the interior cavity of tube 134b and igniter 121. Cups 152a and 152b are positioned proximate respective propagation tube first ends 139-1 and 140-1. During activation of gas generating system 110, cups 152a and 152b can each accommodate a resident interim gas pressure, facilitating ignition of respective gas generants 142a and 142b. A quantity of booster propellant (not shown) may also be positioned in the interior portions of either of cups 152a and 152b to facilitate combustion of respective gas generants 142a and 142b, in a manner known in the art. Cups 152a and 152b may be formed integral with respective propagation tubes 134a and 134b, and may be stamped, cast, or otherwise metal formed and may be made from carbon steel or stainless steel, for example. Alternatively, cups 152a and 152b may be formed separately from tubes 134a and 134b, then attached to respective ones of tubes 134a and 134b (for example, by welding or adhesive attachment) prior to assembly of the gas generating system.

Suitable gas generant compositions are disclosed, for example, in Applicant's U.S. Pat. No. 7,094,296, incorporated herein by reference. Also, other gas generants that should be incorporated by reference in the application include, but are not limited to those described in U.S. Pat. Nos. 5,035,757, and 5,872,329, also incorporated herein by reference. In the embodiment shown in FIGS. 5 and 6, gas generant 142a is in the form of a plurality of annular wafers stacked along tube 134a to substantially enclose tube 134a along a portion of its length. Similarly, gas generant 142b is in the form of a plurality of annular wafers stacked along tube 134b to substantially enclose tube 134b along a portion of its length. Each of the gas generant wafers has a cavity formed therein for receiving a portion of a corresponding propagation tube therethrough, if desired.

It will be appreciated that other, alternative arrangements of the gas generant composition may be used. For example, either (or both) of combustion chambers 110a and 110b may be partially or completely filled with a gas generant in granulated or tablet form. In addition, as stated previously, the position of bulkhead 155 may be adjusted to permit different amounts of gas generant to be positioned in chambers 110a and 110b, thereby enabling the inflation profile to be tailored according to design requirements.

Referring again to FIGS. 5 and 6, one or more spring members 220a are positioned intermediate endcap 115 and gas generant 142a for exerting a force on the gas generant to maintain the wafers or tablets comprising the gas generant in contact with each other. Force is applied by spring members 220a through an endplate 230a movable along cup 152a to press against gas generant 142a. Similarly, one or more spring members 220b are positioned intermediate endcap 120 and gas generant 142b for exerting a force on the gas generant to maintain the wafers or tablets comprising the gas generant in contact with each other. Force is applied by spring members 220b through an endplate 230b movable along cup 152b to press against gas generant 142h. Spring members 220a and 220b and endplates 230a and 230b may be formed from steel or other suitable metal alloys.

A filter 150a is incorporated into the gas generating system design for filtering particulates from gases generated by combustion of gas generant 142a. In general, filter 150a is positioned at an end of combustion chamber 110a, proximate bulkhead 155 and aligned with apertures 123a of inner baffle 122a to help ensure that inflation gas passes through the filter before exiting inner baffle 122a. Similarly, a filter 150b may be incorporated into the gas generating system design for filtering particulates from gases generated by combustion of gas generant 142b. The filters also act as a heat sink to reduce the temperature of the hot inflation gas. In general, filter 150b is positioned at an end of combustion chamber 110b, proximate bulkhead 155 and aligned with apertures 123b of inner baffle 122b to help ensure that inflation gas passes through the filter before exiting inner baffle 122b. Filters 150a and 150b may be formed from compressed knitted metal wire which is commercially available from vendors such as Metex Corp. of Edison, N.J. Alternative filter compositions and structures (not shown) are also contemplated.

A quantity of a known auto-ignition material 128 as previously described is positioned proximate an end of the stack of gas generant material 142a so as to enable fluid communication between the auto-ignition material and the gas generant 142a before and/or after ignition of the auto-ignition material. Similarly, a quantity of a known auto-ignition material 128 as previously described is positioned proximate an end of the stack of gas generant material 142b so as to enable fluid communication between the auto-ignition material and the gas generant 142b before and/or after ignition of the auto-ignition material. As in the previously described embodiment, auto-ignition material 128 is also positioned so as to be in thermal communication with housing 112 such that heat transfer between the housing and the auto-ignition composition is enabled when a portion of the housing not covered by a thermal shield or barrier 901 (described below) is exposed to elevated exterior temperatures. Auto-ignition material 128 is ignited by heat transmitted from an exterior of housing 112 to the interior of the housing due to an elevated external temperature condition (produced, for example, by a fire).

Referring again to FIGS. 5 and 6, a thermal barrier 901 covers a portion of housing 112 exterior of the first chamber 110a. As in the previously described embodiment, portion(s) of the housing in thermal communication with the auto-ignition compound are left uncovered so that heat sufficient to ignite the auto-ignition material may be transferred to the material in a timely manner.

In the multi-chamber embodiment shown in FIGS. 5 and 6, chamber 110a is longer and contains more gas generant 42 than chamber 110b. As stated previously, auto-ignition material 128 is positioned proximate housing ends 114 and 116 and is in thermal communication with the housing at these ends. As the length of housing 112 is increased, the average distance of points along the housing from either end of the housing increases. In addition, as the length of either of gas generant stacks 142a and 142b increases, the average distance of the gas generant in the stack from either end of the housing increases. Thus, for a relatively longer gas generant stack and/or housing (and depending on such factors as where the externally-generated heat impinges upon the housing), a relatively greater length of time may be required for an externally-generated heat source to heat the end(s) of the housing to ignite the auto-ignition material, due to the greater potential separation distance between the heat source and the housing end portion. This separation distance can result in relatively longer-term exposure of a more central portion of the housing to elevated temperatures while the housing ends are heating to a temperature sufficient to ignite the auto-ignition material. Such exposure may cause undesirable damage to the housing or other gas generating system components before the auto-ignition material has been heated sufficiently to ignite. An insulative thermal barrier in accordance with an embodiment of the present invention aids in shielding the covered portion of the housing while sufficient heat is transferred to the auto-ignition material to produce ignition of the auto-ignition material. Thus, the protection afforded housing 112 by the thermal insulation provides additional time for heat received by the uncovered housing portions to raise the temperature of the housing to a point where the auto-ignition material is activated.

In the embodiment shown in FIGS. 5 and 6, the thermal barrier is shown applied to the exterior of the portion of the housing containing the relatively longer gas generant stack 142a. In particular embodiments and depending on the nature of the thermal barrier and the nature of the heat source, heat may also be reflected away from the barrier. In addition, in particular embodiments of the present invention, it is believed that heat impinging on a covered portion of the housing is deflected along the barrier toward one or more exposed ends 114, 116 of the housing. This reflection and/or deflection of the incident heat greatly reduces or eliminates the potential for damage to the housing and/or system components prior to ignition of the auto-ignition material 128.

The exposed or uncovered portions of the housing contain second gas generant chamber 110b housing the relatively shorter gas generant stack 142b, and the average distance from the exposed portion of the housing to the nearest end of the housing is relatively short. Correspondingly, the distance that external heat impinging on this exposed portion of the housing must travel along the housing (via conduction and/or convection) to an end of the housing proximate the auto-ignition material 128 is relatively short. Thus, because of the relatively shorter length of the second chamber 110b and the associated gas generant stack 142b, this portion of the housing exterior may be left uncovered if desired in the embodiment shown in FIGS. 5 and 6.

Thus, in the manner described above, the insulative thermal barriers 900, 901 attenuate or mitigate the effects of elevated external housing temperatures (due, for example, to exposure to flame) on the covered portion(s) of the housing and/or any heat-sensitive internal gas generating system components residing on or within the covered portion of the housing, while still ensuring timely heat transfer to the auto-ignition compound, thereby permitting the auto-ignition compound to activated when desired. This prevents thermally-induced damage to the housing and/or any heat-sensitive internal components while the uncovered portion(s) of the housing is being heated to a temperature sufficient to ignite the associated auto-ignition material.

In a particular embodiment, a “thermal conduit” may be provided extending through or around the insulating structure to the housing. This thermal conduit provides means for enabling thermal communication between the housing unit exterior and an auto-ignition material and/or between the housing unit exterior and a portion of the gas generating system in thermal communication with the auto-ignition material. The auto-ignition material is positioned inside the housing either in operative communication with a gas generant material, or so as to enable operative communication with the gas generant material after activation of the gas generating system.

In one embodiment, the conduit is a thermally-conductive material providing thermal communication between the exterior of the insulating structure and the gas generating system housing, enabling heat from an external source to be transmitted to the portion of the housing proximate the auto-ignition material. Alternatively, the thermal conduit may extend from the exterior of the housing through the housing wall and into the housing interior to permit direct contact with the auto-ignition material inside the housing. Alternatively, the thermal conduit may be an opening formed in the insulating barrier and extending through the harrier from the barrier exterior to a portion of the housing exterior surface proximate and/or in thermal communication with the auto-ignition material.

Use of the thermal conduit obviates the need to position the auto-ignition material in thermal communication with an uncovered portion of the housing, and enhances flexibility in the positioning of the auto-ignition material within the housing.

If desired, at least a portion of the thermal conduit may be thermally insulated so that heat conducted along the conduit is not conducted or otherwise transmitted to a body other than the auto-ignition material in physical contact with the conduit.

In another embodiment, a portion of the thermal conduit is not in direct contact with the housing but is in thermal communication with an exterior of the housing proximate the uncovered portion of the housing, so that heat impinging on the uncovered portion of the housing also impinges on the conduit. This heat is then transmitted along the conduit to an auto-ignition material inside the housing, to ignite the auto-ignition material.

A thermally-conductive material connecting the exterior of the insulation and the gas generating system housing may be molded or formed into the insulating structure, if desired. The thermal conduit may be formed from any suitable thermally-conductive material, for example, copper or a copper-containing alloy.

Referring now to FIG. 7, a gas generating system 10, 110 in accordance with one of the embodiments described herein may be incorporated into a vehicle occupant restraint system 200. Vehicle occupant protection system 200 includes at least one airbag 202 and a gas generating system 10, 110 in accordance with the present invention and coupled to airbag 202 so as to enable fluid communication with an interior of the airbag. Vehicle occupant protection system 200 may be in operative communication with a crash event sensor 211 which communicates with a known crash sensor algorithm that signals actuation of vehicle occupant restraint system 200 via, for example, activation of airbag gas generating system 10, 110 in the event of a collision.

Although the embodiments of the present invention are described herein with reference to a gas generating system having a cylindrically-shaped housing, it will be understood that embodiments of the thermal barrier described herein can be applied to any of a wide variety of alternative housing shapes and configurations. For example, embodiments of the thermal barrier described herein may be applied to gas generating systems having housing formed from a base and cap, rather than a cylindrical tube. Embodiments of the thermal barrier described herein may be also applied to gas generating systems having multiple combustion chambers. Application of embodiments of the thermal barrier to numerous other types and structures of gas generating systems is also contemplated.

It will be understood that the foregoing description of the present invention is for illustrative purposes only, and that the various structural and operational features herein disclosed are susceptible to a number of modifications, none of which departs from the spirit and scope of the present invention. The preceding description, therefore, is not meant to limit the scope of the invention. Rather, the scope of the invention is to be determined only by the appended claims and their equivalents.

What is claimed is:

1. A housing unit for a gas generating system, the housing unit comprising a housing and a thermally insulative barrier covering at least a portion of an exterior of the housing.

2. A housing unit in accordance with claim 1 wherein the thermal barrier includes a heat-reflective material.

3. A housing unit in accordance with claim 1 wherein the thermal barrier includes a flame-retardant material.

4. A gas generating system including a housing unit in accordance with claim 1.

5. A vehicle occupant protection system including a gas generating system in accordance with claim 4.

6. A housing unit in accordance with claim 1 wherein the housing is insert molded into the at least a portion of the thermal barrier.

7. A housing unit in accordance with claim 1 wherein the thermal barrier is formed into a receptacle configured for receiving the at least a portion of the housing therein.

8. The housing unit of claim 1 wherein the insulative barrier comprises a plurality of layers of material.

9. The housing unit of claim 1 wherein the housing includes at least one gas exit orifice to enable fluid communication between an interior of the housing and an exterior of the housing after activation of the gas generating system, and wherein the housing unit includes means for enabling a flow of generated gases from the housing through the thermal barrier after activation of the gas generating system.

10. A housing unit in accordance with claim 1 wherein a portion of the housing is not covered by the thermal barrier, and further comprising an auto-ignition material positioned inside the housing in thermal communication with the uncovered portion of the housing.

11. The housing unit of claim 1 further comprising means enabling thermal communication between an exterior of the insulative barrier and an auto-ignition material positioned within the housing.

12. The housing unit of claim 11 wherein the means enabling thermal communication comprises an opening formed in the insulative barrier and extending through the barrier from the barrier exterior to a portion of the housing exterior surface in thermal communication with the auto-ignition material.

13. The housing unit of claim 11 wherein the means enabling thermal communication comprises a thermally-conductive material extending through the barrier to a portion of the housing in thermal communication with the auto-ignition material.

14. The housing unit of claim 13 wherein the thermally-conductive material extends through a wall of the housing.

15. A housing unit for a gas generating system, the housing unit comprising a housing and a thermally insulating barrier covering a portion of the housing so as to provide heating of an uncovered portion of the housing adjacent the covered portion at a greater rate than heating of the covered portion when heat from a heat source external to the housing impinges on the covered portion.

16. A gas generating system including a housing unit in accordance with claim 15.

17. A vehicle occupant protection system including a gas generating system in accordance with claim 16.

18. A housing unit for a gas generating system, the housing unit comprising a longitudinal housing having an interior divided into first and second chambers, and a thermally insulating barrier covering a portion of the housing exterior of the first chamber.

19. A gas generating system including a housing unit in accordance with claim 19.

20. A vehicle occupant protection system including a gas generating system in accordance with claim 19.
